(19) United States
(12) Patent Application Publication
(10) Pub. No.: US 2015/0154656 A1
(43) Pub. Date: Jun. 4, 2015

(54) SYSTEM AND METHOD FOR PROVIDING ADDITIONAL INFORMATION OF ADVERTISEMENT

(71) Applicant: ELECTRONICS AND TELECOMMUNICATIONS RESEARCH INSTITUTE, Daejeon (KR)

(72) Inventors: Young Suk YOON, Cheongju-si (KR); Jee Hyun PARK, Daejeon (KR); Jung Hyun KIM, Daejeon (KR); Yong Seok SEO, Daejeon (KR); Won Young YOO, Daejeon (KR); Young Ho SUH, Daejeon (KR)

(21) Appl. No.: 14/543,974

(22) Filed: Nov. 18, 2014

(30) Foreign Application Priority Data
Nov. 29, 2013 (KR) 10-2013-0147864

(51) Int. Cl. G06Q 30/02

(52) U.S. Cl. CPC G06Q 30/0276

(57) ABSTRACT

Provided is an advertisement service system for providing additional information regarding an item as an advertisement target. The system for providing additional information of an advertisement includes an original advertisement server configured to provide original advertisement content and identification information regarding the original advertisement content, and a processing server configured to generate processed advertisement content by inserting the identification information into the original advertisement content, extract feature information with respect to the original advertisement content, and store at least one of the identification information and the feature information, together with additional information with respect to the original advertisement content.

### CROSS-REFERENCE TO RELATED APPLICATIONS

This application claims priority under 35 U.S.C. §119 to Korean Patent Application No. 10-2013-0147864, filed on Nov. 29, 2013, the disclosure of which is incorporated herein by reference in its entirety.

### TECHNICAL FIELD

The present invention relates to a system for providing advertisement information, and more particularly, to a system for providing additional information regarding an item as an advertisement target.

### BACKGROUND

The prevalence of smart devices has spurred a rapid increase in the number of portable terminals available to execute various programs (applications, apps, and the like) through a multi-screen function thereof. Consumers with market power (or purchasing power) may search for information on articles or goods using their portable terminals naturally anytime and anywhere when they see or hear an advertisement promoting articles or goods arousing customers' interest, as well as when purchasing articles or goods in stores or market.

Existing methods includes a method in which consumers who are interested in purchasing the goods directly search for information of relevant goods or a method in which a system, which has received a broadcast in which a relevant message is in a network packet state or inserted into a header of content, displays information according to consumers' request.

However, currently, goods are advertised using various methods such as digital signage and media façade, as well as public transportation systems (buses, subways, etc.), station waiting rooms, for example, crowded with people, regardless of time and place. Thus, in order to automatically transfer relevant information regarding an advertisement to a user (a viewer) who has the potential to purchase, and induce active participation of the user, a service for transferring relevant additional information of corresponding goods, as customized information, to a user who satisfies various conditions (age, gender, the number of viewing, interested area, and the like) or automatically issuing a coupon to the user is required.

### SUMMARY

Accordingly, the present invention provides a system and method for providing additional information with respect to an advertisement by inserting identification information into advertisement content or extracting feature information with respect to advertisement content.

The object of the present invention is not limited to the aforesaid, but other objects not described herein will be clearly understood by those skilled in the art from descriptions below.

In one general aspect, a system for providing additional information of an advertisement includes: an original advertisement server configured to provide original advertisement content and identification information regarding the original advertisement content; and a processing server configured to generate processed advertisement content by inserting the identification information into the original advertisement content, extract feature information with respect to the original advertisement content, and store at least one of the identification information and the feature information, together with additional information with respect to the original advertisement content.

The processing server may insert the identification information into an audio signal or a video signal constituting the original advertisement content by using a data hiding technique.

The processing server may store the identification information and the feature information paired with the identification information, together with the additional information.

The additional information may include basic advertisement information, goods associated information, event associated information, and a goods voucher. For example, the basic advertisement information may include an advertisement continuity (or conti), a background, a character, product information, and the like.

In another general aspect, a system for providing additional information of an advertisement includes: an original advertisement server configured to provide original advertisement content and identification information regarding the original advertisement content; a processing server configured to generate processed advertisement content by inserting the identification information into the original advertisement content, extract feature information with respect to the original advertisement content, and store at least one of the identification information and the feature information, together with additional information with respect to the original advertisement content; a media device configured to display the processed advertisement content transmitted from the processing server; and a user terminal configured to display the additional information by using the identification information or the feature information obtained from the processed advertisement content displayed on the media device.

The user terminal may obtain the identification information inserted in an audio signal or a video signal constituting the processed advertisement content by using a data hiding detection technique.

The user terminal may extract the feature information from the processed advertisement content by using any one of algorithms among zero crossing rate (ZCR), an energy difference, spectral flatness, mel frequency cepstral coefficient (MFCC), and frequency centroids, representing time/frequency feature information with respect to the audio signal and by using any one of algorithms among temporal, spatial, and spatio-temporal feature information with respect to the video signal.

The user terminal may obtain the additional information by using statistical characteristics with respect to one or more feature information obtained from the processed advertisement content for a pre-set period of time.

The processing server may receive the identification information or the feature information obtained by the user terminal from the user terminal, and transmit the additional information corresponding to the identification information or the feature information to the user terminal.

In another general aspect, a method for providing additional information of an advertisement includes: receiving original advertisement content and identification information regarding the original advertisement content; generating processed advertisement content by inserting the identification information into the original advertisement content; extracting feature information with respect to the original advertisement content; storing at least one of the identification information and the feature information, together with additional information with respect to the original advertisement content; and transmitting the processed advertisement content to a media device.

The generating of processed advertisement content may include inserting the identification information into an audio signal or a video signal constituting the original advertisement content by using a data hiding technique.

The storing may include storing the identification information and the feature information paired with the identification information, together with the additional information.

The method may further include: receiving the identification information or the feature information obtained by the user terminal from the processed advertisement content displayed on the media device; and transmitting additional information corresponding to the identification information or the feature information received from the user terminal, to the user terminal.

### BRIEF DESCRIPTION OF THE DRAWINGS

FIG. 1 is a view illustrating an example of a system for providing additional information of an advertisement according to an embodiment of the present invention.

FIG. 2 is a view illustrating an internal configuration of a processing server of FIG. 1.

FIG. 3 is a view illustrating an internal configuration of a user terminal of FIG. 1.

FIG. 4 is a view illustrating an example of a method for providing additional information of an advertisement according to another embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

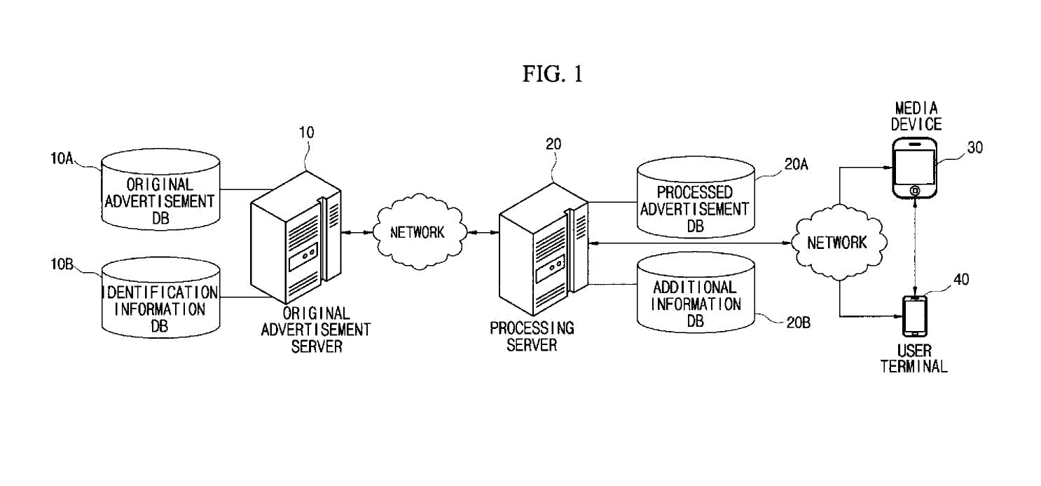

FIG. 1 is a view illustrating an example of a system for providing additional information of an advertisement according to an embodiment of the present invention.

The system for providing additional information of an advertisement of FIG. 1 includes an original advertisement server 10, a processing server 20, a media device 30, and a user terminal 40.

The original advertisement server 10 refers to a terminal of an advertiser or a terminal of a broadcaster and provides original advertisement content and identification information for identifying the original advertisement content. To this end, the original advertisement server 10 may include an original advertisement database (DB) 10a storing original advertisement content items and an identification information DB 10b storing identification information for identifying original advertisement content items.

The processing server 20 is connected to the original advertisement server 10 via a network and receives original advertisement content and identification information from the original advertisement server 10.

The processing server 20 preprocesses the original advertisement content and subsequently inserts the identification information into an audio signal, a video signal, or an audio signal and a video signal of the preprocessed original advertisement content. The processed advertisement content with the identification information inserted therein is stored in the processed advertisement DB 20a.

Here, the processing server 20 inserts the identification information using a data hiding technique such that users viewing advertisement content may not recognize the inserted identification information.

For example, the processing server 20 may insert the identification information into the original advertisement content by selectively using various known data hiding algorithms.

The processing server 20 extracts feature information (fingerprint, feature, or DNA) from the received original advertisement content. Extraction of the feature information from the original advertisement content may be performed in parallel with insertion of the identification information or may be selectively performed.

Here, the extracted feature information is used for the purpose of identifying the original advertisement content (or particular additional information) over other original advertisement content (or other additional information), together with the identification information or separately from the identification information. For example, when it is assumed that identification information, a unique advertisement key value inserted into advertisement content A, is FM_{A}—(identification information ForensicMark for hiding data of advertisement A)—and feature information extracted from the advertisement content A is F_{A}(1)—(#1 feature information of advertisement A, Fingerprint), F_{A}(2), . . . , F_{A}(n), the advertisement content A may be distinguished from other content by only the identification information FM_{A}, by only the feature information F_{A}(1), by only the feature information F_{A}(1) and F_{A}(2), or by only the identification information FM_{A} and the feature information F_{A}(1).

Namely, the original advertisement content may be differentiated from other content through various combinations in which identification information or feature information are paired, and the present invention provides a scheme of identifying content resistant to an external environment capable of increasing accuracy and a speed of identifying original content even in an environment in which any one of identification information and feature information is difficult to obtain, for example, even in an external environment with severe noise.

The processing server 20 stores at least one of the identification information and the feature information, together with additional information provided for the original advertisement content, in the additional information DB 20b.

Here, the additional information refers to information additionally provided to the original advertisement content and may include, for example, basic advertisement information, goods associated information, event associated information, and a goods voucher. Here, the basic advertisement information includes an advertisement continuity (or conti), a background, a character, product information, and the like.

For example, when there is an advertisement of soccer shoes in which Ronaldo wearing a new product of soccer shoes to Nike, Inc. is present, fancy dribbling techniques of Ronaldo may be shown, rarely exposing information on soccer shoes, and the advertisement may be switched to other advertisement. In this case, since the viewed advertisement is switched to other advertisement, curiosity of a viewer who might have felt like purchasing the soccer shoes may be changed to other products, resulting in a discouraged purchase desire.

In order to prevent this, in an embodiment of the present invention, additional information of an advertisement which has been viewed by a viewer is searched and transmitted to a second screen or a multi-screen of the viewer. The viewer may then receive the additional information related to the advertisement without any additional manipulation.

The processed advertisement content generated by the processing server 20 may be transmitted to a TV, a radio, a kiosk, a digital signage, a media façade, and even a waiting number ticket liquid crystal screen used in a café, and the like, and displayed.

The viewer may access various advertisements anytime and anywhere through the foregoing media device, and obtain additional information corresponding to the processed advertisement content through any type of user terminal 40 that may be able to obtain an advertisement signal from the processed advertisement content displayed on the media device.

In a specific embodiment, the user terminal 40 obtains an audio signal or a video signal from the processed advertisement content through a microphone or a camera, and detects identification information inserted in the obtained audio signal or video signal.

Here, the user terminal 40 may detect the identification information using a data hiding detection technique.

The user terminal 40 may extract feature information from the input audio signal or video signal.

For example, extraction of feature information from the input audio signal may be performed using any one of known feature information extraction algorithms. Also, statistical characteristics with respect to one or more feature information obtained for a pre-set period of time may be utilized for content searching.

Here, as the feature information extraction algorithm, any one of algorithms such as zero crossing rate (ZCR), an energy difference, spectral flatness, mel frequency cepstral coefficient (MFCC), frequency centroids, and the like, including time/frequency feature information, is used.

In another embodiment, extraction of feature information from an input video signal may use time/space/space-time feature information of a video signal.

The identification information detected by the user terminal 40 or feature information extracted by the user terminal 40 is transmitted to the processing server 20 via a network, and the processing server 20 returns additional information corresponding to the transmitted identification information or feature information to the user terminal 40.

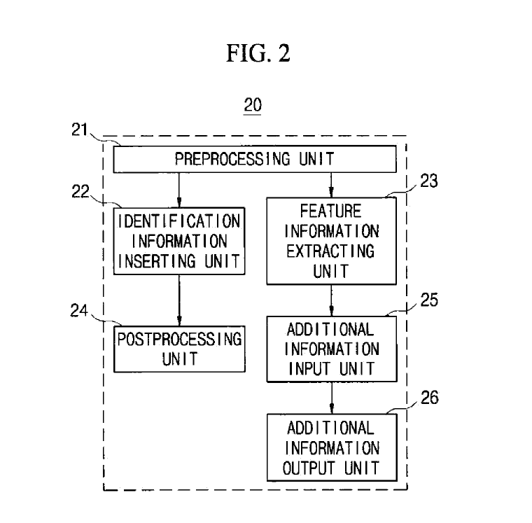

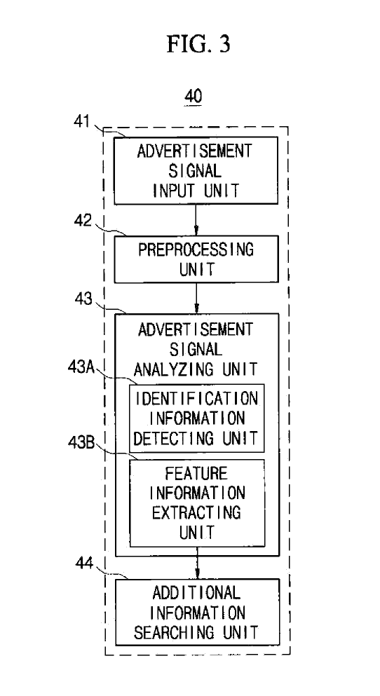

Hereinafter, internal configurations of the processing server 20 and the user terminal 40 described above with reference to FIG. 1 will be described in detail with reference to FIGS. 2 and 3.

FIG. 2 is a view illustrating an internal configuration of the processing server of FIG. 1, and FIG. 3 is a view illustrating an internal configuration of the user terminal of FIG. 1.

Referring to FIG. 2, the processing server 20 includes a preprocessing unit 21, an identification information inserting unit 22, a feature information extracting unit 23, a postprocessing unit 24, an additional information input unit 25, and an additional information extracting unit 26.

The preprocessing unit 21 processes an input signal in order to insert identification information impossible to recognize into original advertisement content.

For example, an input advertisement signal may include an audio signal, a video signal, or an audio signal and a video signal, and in order to process these signals, the preprocessing unit 21 may include a demultiplexer (DEMUX), an audio decoder, a video decoder, an audio resampler, a video resampler, an audio noise canceller, and a video noise canceller.

The demultiplexer separates an advertisement signal including an audio signal and a video signal into an audio signal and a video signal. The demultiplexer does not operate in an advertisement signal including only an audio signal or only a video signal, and this is the same in a following process.

The audio decoder decodes a compressed audio advertisement signal.

The video decoder decodes a compressed video advertisement signal.

The audio resampler temporally resamples the decoded audio advertisement signal in order to normalize it.

The video resampler spatio-temporally resamples the decoded video advertisement signal to normalize it. The temporal resampling is resizing to change a frame rate, and the spatial resampling is resizing to change a frame size.

The audio noise canceller cancels noise from the normalized audio advertisement signal.

The video noise canceller cancels noise from the normalized video advertisement signal.

The identification information inserting unit 22 inserts identification information into the preprocessed audio signal or video signal of the original advertisement content in order to identify the original advertisement content. Here, the identification information is an advertisement key value such as an ID for identifying an advertisement signal, for example, and is inserted according to a data hiding technique such that users cannot recognize the identification information.

The feature information extracting unit 23 extracts feature information from the preprocessed audio signal or video signal of the original advertisement content.

For example, in case of the audio signal, the feature information extracting unit 23 obtains features at every predetermined amount of time, quantizes the extracted features, and converts the quantized features into an n-digit binary variable. Alternatively, the feature information extracting unit 23 may extract feature information from the audio signal by using any one of feature information extraction algorithms among time/frequency feature information such as zero crossing rate (ZCR), an energy difference, spectral flatness, mel frequency cepstral coefficient (MFCC), frequency centroids, and the like.

In another example, in case of the video signal, the feature information extracting unit 23 may obtain a global feature such as a color histogram or an edge histogram in a stationary image from every block or may adopt spatial feature information extracting regional feature, temporal feature information using information such as an optical flow, a motion vector, a scene, or the like, and spatio-temporal feature information using 3D conversion, by using a Harris corner detector known as a corner point detector for detecting a corner from a noise-canceled image based on Gaussian filtering.

The postprocessing unit 24 stores the processed advertisement content created by inserting the identification information into the original advertisement content, as a format to be transmitted, in the processed advertisement DB 20a.

In an embodiment, the postprocessing unit 24 may include an audio encoder, a video encoder, and a multiplexer.

The audio encoder encodes the audio advertisement signal including the identification information output from the identification information inserting unit 22.

The video encoder encodes the video advertisement signal including the identification information output from the identification information inserting unit 22.

Upon receiving the encoded signals, the multiplexer generates an audio advertisement signal, a video advertisement signal, or an audio and video advertisement signal each including the identification information.

The additional information input unit 25 stores at least one of the identification information and the feature information, together with the additional information regarding the original advertisement content, in the additional information DB 20b.

As discussed above, extraction of the feature information from the original advertisement content may be selectively performed, and also, even w hen the feature information extracting unit 23 extracts feature information with respect to the original advertisement content, the feature information may be selectively stored together with the additional information.

In an embodiment, the additional information input unit 25 may configure the identification information and the feature information inserted in the original advertisement content, as a pair, and store the same together with the additional information with respect to the original advertisement content in the additional information DB 20b.

In another embodiment, the additional information input unit 25 may store only the identification information, together with the additional information, in the additional information DB 20b, or may store only the feature information, together with the additional information, in the additional information DB 20b. Here, the identification information or feature information stored together with the additional information is used as an index for additional information searching.

The additional information output unit 26 compares the identification information or the feature information transmitted from the user terminal 40 with the identification information or the feature information stored in the additional information DB 20b to search for additional information corresponding to the identification information or the feature information. Searched additional information is transmitted to the user terminal 40 connected via the network, and the user terminal 40 outputs the received additional information.

Meanwhile, an advertisement processed by the processing server 20 may be output from various media devices 30 such as a TV, a radio set, a kiosk, a digital signage, a media façade, and even a waiting number ticket liquid crystal screen used in a café. Here, the output advertisement has identification information inserted therein. An advertisement viewer may view an advertisement with various media devices 30 anytime and anywhere. The viewer may receive additional information regarding an advertisement by analyzing and searching for an advertisement signal using various types of user terminals 40, including a smart device, which may be able to receive an advertisement signal. Hereinafter, a specific configuration of the user terminal 40 outputting additional information will be described with reference to FIG. 3.

FIG. 3 is a view illustrating an internal configuration of the user terminal of FIG. 1.

Referring to FIG. 3, the user terminal 40 includes an advertisement signal input unit 41, a preprocessing unit 42, an advertisement signal analyzing unit 43, and an additional information searching unit 44.

The advertisement signal input unit 41 captures an advertisement signal output from the media device 40 to receive an audio signal or a video signal. For example, the advertisement signal input unit 41 may receive an audio signal through a microphone and receive a video signal from an image captured by a camera.

The preprocessing unit 42 may be used in the same manner as that of the preprocessing unit 21 of the processing server 20. However, since degrees of added noise are different according to environments in which an audio signal and a video signal are obtained, the preprocessing unit 42 may be selectively used in various types of noise canceling techniques.

The advertisement signal analyzing unit 43 detects identification information inserted into the noise-canceled audio signal or video signal, and extracts feature information from the audio signal or the video signal. For example, the advertisement signal analyzing unit 43 may include an identification information detecting unit 43a and a feature information extracting unit 43b. Here, the identification information detecting unit 43a operates as a pair with the identification information inserting unit 22 of the processing server 20. Thus, the advertisement signal analyzing unit 43 may obtain the inserted identification information by using a data hiding detection technique.

A feature information extraction algorithm used in the feature information extracting unit 43b may be identical to the feature information extraction algorithm used in the feature information extracting unit 23 of the processing server 20. The feature information extracting unit 43b may extract feature information identical or similar to the feature information extracted by the processing server 20, through the same algorithm. Here, the feature information extracting unit 43b should extract feature information from the audio signal or video signal attenuated due to noise canceling. Thus, the feature information should have characteristics of being resistant to noise, having pairwise independence, providing DB efficiency, and allowing for real-time searching.

The additional information searching unit 44 delivers the identification information or feature information detected by the advertisement signal analyzing unit 43 to the processing server 20, and receives additional information searched by the processing server 20 and outputs the same.

The system for providing additional information of an advertisement according to an embodiment of the present invention has been described. Hereinafter, a process of providing additional information to a user terminal by using identification information or feature information in a system for providing additional information of an advertisement will be described.

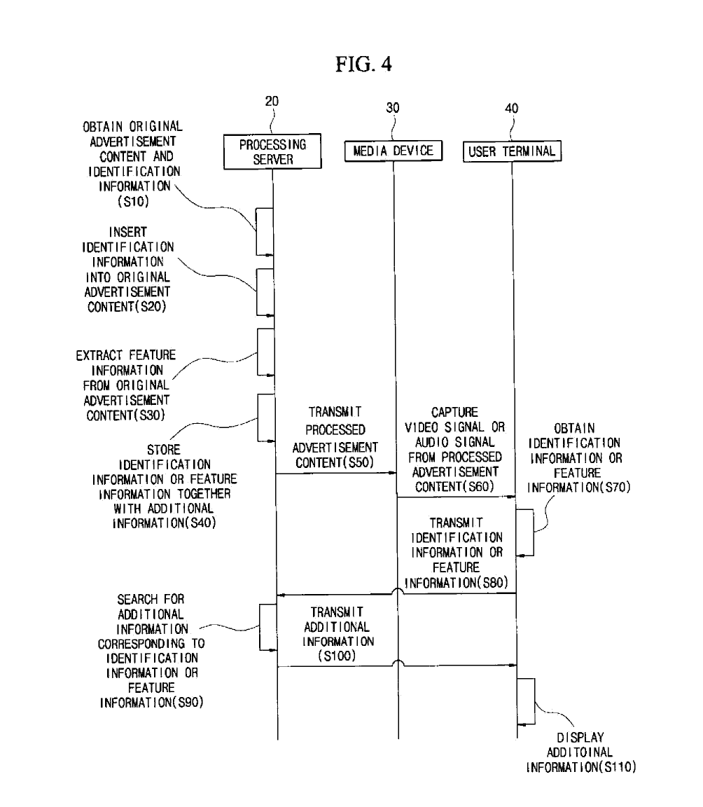

FIG. 4 is a view illustrating an example of a method for providing additional information of an advertisement according to another embodiment of the present invention.

Referring to FIG. 4, in step S10, the processing server 20 obtains original advertisement content and identification information for identifying the original advertisement content from other content, from the original advertisement server 10.

In step S20, the processing server 20 inserts the identification information into the original advertisement content. Here, the processing server 20 inserts the identification information into the original advertisement content by using a data hiding technique, and thus, users who are viewing the advertisement content cannot recognize the inserted identification information.

In step S30, the processing server 20 extracts feature information from the original advertisement content in parallel with step S20 of inserting the identification information, or selectively.

When the original advertisement content includes only an audio signal, the processing server 20 extracts feature information with respect to the audio signal. When the original advertisement content includes only a video signal, the processing server 20 extracts feature information with respect to the video signal. When the original advertisement content includes both an audio signal and a video signal, the processing server 20 extracts feature information with respect to all the signals.

In order to extract the feature information from the audio signal or the video signal, various types of known algorithms may be selectively used, and the extracted feature information may be two or more feature information items or may be statistical characteristics with respect to a plurality of feature information items according to circumstances.

The identification information or feature information is utilized as an index for searching for additional information with respect to the original advertisement content.

In step S40, the processing server 20 stores the identification information or feature information, together with the additional information with respect to the original advertisement content, in the additional information DB 20b. In step S50, the processing server 20 transmits the identification information-inserted original advertisement content (processed advertisement content) to the media device 30. The media device 30 may be a TV, a radio set, a kiosk, a digital signage, a media façade, and even a waiting number ticket liquid crystal screen used in a café. An advertisement viewer may view an advertisement with various media devices 30 anytime and anywhere.

In step S60, the user terminal 40 obtains the audio signal or the video signal from the processed advertisement content output from the media device 30.

For example, the user terminal 40 may obtain the audio signal through a microphone and the video signal from an image captured by a camera.

In step S70, the user terminal 40 detects the inserted identification information from the audio signal or the video signal, or extracts feature information.

Various types of noise may be included in the audio signal or the video signal depending on an environment in which processed advertisement content is output from the media device 30, and the user terminal 40 may detect or extract only any one of the identification information and the feature information according to circumstances.

The user terminal 40 transmits the extracted identification information or feature information to the processing server 20 in step S80, and the processing server 20 searches for additional information matched to the received identification information or feature information in step S90. Here, the processing server 20 uses the identification information or feature information inserted or extracted in step S20 or in step S30 as an index of searching.

In step S100, the processing server 20 transmits the searched additional information to the user terminal 40, and the user terminal 40 outputs the received additional information in step S110.

According to the embodiments of the present invention as described above, a viewer (or a user) who is interested in an advertisement may be provided with additional information related to an advertisement anytime and anywhere, and an advertiser or a goods seller may achieve promotion of goods sales.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for providing additional information of an advertisement, the system comprising:
an original advertisement server configured to provide original advertisement content and identification information regarding the original advertisement content; and
a processing server configured to generate processed advertisement content by inserting the identification information into the original advertisement content, extract feature information with respect to the original advertisement content, and store at least one of the identification information and the feature information, together with additional information with respect to the original advertisement content.

2. The system of claim 1, wherein the processing server inserts the identification information into an audio signal or a video signal constituting the original advertisement content by using a data hiding technique.

3. The system of claim 1, wherein the processing server stores the identification information and the feature information paired with the identification information, together with the additional information.

4. The system of claim 1, wherein the additional information comprises basic advertisement information, goods associated information, event associated information, and a goods voucher.

5. A system for providing additional information of an advertisement, the system comprising:
an original advertisement server configured to provide original advertisement content and identification information regarding the original advertisement content;
a processing server configured to generate processed advertisement content by inserting the identification information into the original advertisement content, extract feature information with respect to the original advertisement content, and store at least one of the identification information and the feature information, together with additional information with respect to the original advertisement content;
a media device configured to display the processed advertisement content transmitted from the processing server; and
a user terminal configured to display the additional information by using the identification information or the feature information obtained from the processed advertisement content displayed on the media device.

6. The system of claim 5, wherein the user terminal obtains the identification information inserted in an audio signal or a video signal constituting the processed advertisement content by using a data hiding detection technique.

7. The system of claim 5, wherein the user terminal extracts time/frequency feature information from the audio signal of the processed advertisement content and extracts temporal/spatial/spatio-temporal feature information from the video signal of the processed advertisement content.

8. The system of claim 5, wherein the user terminal obtains the additional information by using statistical characteristics with respect to one or more feature information obtained from the processed advertisement content for a pre-set period of time.

9. The system of claim 5, wherein the processing server receives the identification information or the feature information obtained by the user terminal from the user terminal, and transmits the additional information corresponding to the identification information or the feature information to the user terminal.

10. A method for providing additional information of an advertisement, the method comprising:
receiving original advertisement content and identification information regarding the original advertisement content;
generating processed advertisement content by inserting the identification information into the original advertisement content;
extracting feature information with respect to the original advertisement content;
storing at least one of the identification information and the feature information, together with additional information with respect to the original advertisement content; and
transmitting the processed advertisement content to a media device.

11. The method of claim 10, wherein the generating of processed advertisement content comprises inserting the identification information into an audio signal or a video signal constituting the original advertisement content by using a data hiding technique.

12. The method of claim 10, wherein the storing comprises storing the identification information and the feature information paired with the identification information, together with the additional information.

13. The method of claim 10, further comprising:
receiving the identification information or the feature information obtained by the user terminal from the processed advertisement content displayed on the media device; and
transmitting additional information corresponding to the identification information or the feature information received from the user terminal, to the user terminal.
